(19) United States
(12) Patent Application Publication
(10) Pub. No.: US 2021/0049553 A1
(43) Pub. Date: Feb. 18, 2021

(54) Rate Ingestion Tool

(71) Applicant: VOUCH, INC., San Francisco, CA (US)

(72) Inventors: Stanley Lin, North York (CA); Alex Stupakov, San Francisco, CA (US); Evan Roman, San Francisco, CA (US)

(73) Assignee: VOUCH, INC., San Francisco, CA (US)

(21) Appl. No.: 16/873,906

(22) Filed: Aug. 6, 2020

Related U.S. Application Data
(60) Provisional application No. 62/922,561, filed on Aug. 15, 2019.

(51) Int. Cl. G06Q 10/10; G06Q 40/08; G06F 16/22; G06F 16/25; G06F 40/51

(52) U.S. Cl. CPC G06Q 10/101; G06Q 40/08; G06F 40/51; G06F 16/254; G06F 16/2282

(57) ABSTRACT

The present invention is generally directed to systems and methods for data ingestion related to business insurance. It is more specifically directed to systems and methods for developing a code set for a business insurance product. In one aspect, the present invention provides a method of developing an insurance code set. The method comprises the steps of: using one or more data ingestion tools to identify and extract claim events from available databases; translating each claim event into one or more sentences using a natural language processing model; storing the one or more sentences in a database in a tabular format; accessing the tabular format and assigning a code to each entry, thereby developing an insurance code set.

### FIELD OF THE INVENTION

The present invention is generally directed to systems and methods for data ingestion related to business insurance. It is more specifically directed to systems and methods for developing a code set for a business insurance product.

### BACKGROUND OF THE INVENTION

There have been reports of methods for data ingestion. For instance, U.S. Pat. Pub. No. 2019/236197, entitled “Data Ingestion by Distributed-Computing Systems”, allegedly reports the following: “Techniques for data ingestion by a distributed-computing system are provided. In one embodiment, data received from one or more data sources is processed at a management node of the distributed-computing system. The data is generated by one or more components of an information processing system external to the distributed-computing system. The data is stored at the management plane. The management plane selects, from a plurality of data cores, a data core to ingest the data. The plurality of data cores are stored across one or more data plane containers of a data plane of the distributed-computing system. The management plane processes the data to generate one or more event records corresponding to the data. The one or more event records are sent to the selected data core, which causes the data plane to store the one or more event records in the selected data core.” Abstract.

U.S. Pat. Pub. No. 2019/220459, entitled “Batch Data Ingestion in Database Systems”, allegedly reports the following: “Systems, methods, and devices for batch ingestion of data into a table of a database. A method includes determining a notification indicating a presence of a user file received from a client account to be ingested into a database. The method includes identifying data in the user file and identifying a target table of the database to receive the data in the user file. The method includes generating an ingest task indicating the data and the target table. The method includes assigning the ingest task to an execution node of an execution platform, wherein the execution platform comprises a plurality of execution nodes operating independent of a plurality of shared storage devices collectively storing database data. The method includes registering metadata concerning the target table in a metadata store after the data has been fully committed to the target table by the execution node.” Abstract.

U.S. Pat. Pub. No. 2018/218069, entitled “Massive Scale Heterogeneous Data Ingestion and User Resolution”, allegedly reports the following: “This disclosure relates to data association, attribution, annotation, and interpretation systems and related methods of efficiently organizing heterogeneous data at a massive scale. Incoming data is received and extracted for identifying information (“information”). Multiple dimensionality reducing functions are applied to the information, and based on the function results, the information are grouped into sets of similar information. Filtering rules are applied to the sets to exclude non-matching information in the sets. The sets are then merged into groups of information based on whether the sets contain at least one common information. A common link may be associated with information in a group. If the incoming data includes the identifying information associated with to the common link, the incoming data is assigned the common link. In some embodiments, incoming data are not altered but assigned into domains.” Abstract.

Despite the reports, there is still a need in the art for new systems and method for data ingestion related to business insurance.

### SUMMARY OF THE INVENTION

In one aspect, the present invention provides a method of developing an insurance code set. The method comprises the steps of: using one or more data ingestion tools to identify and extract claim events from available databases; translating each claim event into one or more sentences using a natural language processing model; storing the one or more sentences in a database in a tabular format; accessing the tabular format and assigning a code to each entry, thereby developing an insurance code set.

In another aspect, the present invention provides a computer system for developing an insurance code set. The system comprises: one or more processor; and one or more storage devices having stored thereon computer-executable instructions, which are executable by the one or more processors to cause the computer system to: use one or more data ingestion tools to identify and extract claim events from available databases; translate each claim event into one or more sentences using a natural language processing model; store the one or more sentences in a database in a tabular format; access the tabular format and assigning a code to each entry, thereby developing an insurance code set.

In another aspect, the present invention provides one or more hardware storage devices having stored thereon computer-executable instructions. The instructions are executable by one or more processors of a computing system to cause the computer system to: use one or more data ingestion tools to identify and extract claim events from available databases; translate each claim event into one or more sentences using a natural language processing model; store the one or more sentences in a database in a tabular format; access the tabular format and assigning a code to each entry, thereby developing an insurance code set.

### BRIEF DESCRIPTION OF THE DRAWINGS

FIG. 1 is a flow diagram illustrating an exemplary method of insurance code generation (100).

FIG. 2 is an illustration of an exemplary computer readable medium where processor-executable instructions are configured to embody one or more of the provisions set forth herein may be comprised.

FIG. 3 illustrates an exemplary computing environment wherein one or more of the provisions set forth herein may be implemented.

### DETAILED DESCRIPTION OF THE INVENTION

The present invention is generally directed to systems and methods for data ingestion related to business insurance. It is more specifically directed to systems and methods for developing a code set for a business insurance product.

“Data ingestion” refers to the process of importing, transferring, loading and processing data in a database. The process includes loading data from different sources, altering and modifying individual files and formatting them to insert them into a document. Data ingestion can be continuous, asynchronous, real-time or batched.

“Data ingestion tool” refers to a software system for performing data ingestion. Nonlimiting examples of data ingestion tools include the following: Amazon Kinesis; Apache Flume; Apache Kafka; Apache NIFI; Apache Samza; Apache Sqoop; Apache Storm; DataTorrent; Gobblin; Syncsort; Wavefront; Cloudera Morphlines; White Elephant; Apache Chukwa; Fluentd; Heka; Scribe; Databus; and various web scraping tools. A primary objective of data ingestion tools is the extraction of data.

“Web scraping tool” refers to tools that provide for extracting data from complex formats such as PDF or one or more websites. The tools enable one to scrape, or free, data from websites run by governments, state institutions and organizations to access data that may be published or distributed in open format. Nonlimiting examples of web scraping tools include: ImportHTML formula; Table Capture; ScraperWiki; Tabula; Import.io; Beautiful Soup; Python Mechanize; and, Scrapy.

Nonlimiting examples of business risks include: strategic risk; compliance risk; operational risk; reputational risk; implementation risk; pervasiveness risk; and preparedness risk.

“Strategic risk” refers to the risk that failed business decisions, or lack thereof, may pose to a company. Tools one can use to minimize strategic risk include, without limitation: business plan guidelines/templates; guidelines/checklists for retaining one or more outside advisors (e.g., scientific/technical advisory board); guidelines/checklists for retaining one or more board members; guidelines/templates/checklists for scenario planning; guidelines/checklists for establishing a competitive intelligence program.

“Compliance risk” refers to exposure to legal penalties, financial forfeiture and material loss an organization faces when it fails to act in accordance with industry laws and regulations, internal policies or prescribed best practices. Tools one can use to minimize compliance risks include, without limitation: guidelines/templates/checklists for a compliance audit; guidelines/checklists for establishing searches directed to changing laws or legal frameworks applicable to the subject business.

“Operational risk” refers to the risk of a change in value caused by the fact that actual losses, incurred for inadequate or failed internal processes, people and systems, or from external events, differ from the expected losses. Tools one can use to minimize operational risks include, without limitation: guidelines/templates/checklists for clauses within various contract types (e.g., indemnification, liability limitation and warranty clauses); guidelines/templates/checklists directed to processes for protecting intellectual property; guidelines/templates/checklists directed to documentation of manufacturing and/or development processes; guidelines/templates/checklists for cybersecurity processes.

“Reputational risk” refers to the potential loss to financial capital, social capital and/or market share resulting from damages to a company's reputation. Tools one can used to minimize reputational risk include, without limitation: guidelines/templates/checklists for employee, manager, officer, director and strategic advisor use of social media; guidelines/templates/checklists for establishing searches directed to company reputation; guidelines/templates/checklists for surveying key partners and/or customers.

“Implementation risk” refers to the potential for a development or deployment failure. The term is often used for risks related to a production launch. Tools one can use to minimize implementation risk include, without limitation: guidelines/templates/checklists for establishment of project management with respect to key projects; guidelines/templates/checklists for project audits; guidelines/templates/checklists for training employees charged with project tasks.

“Pervasiveness risk” refers to the effects on the financial report of misstatements or the possible effects on the financial report of misstatements, if any, that are undetected due to an inability to obtain sufficient appropriate audit evidence. Tools one can use to minimize pervasiveness risk include, without limitation: guidelines/templates/checklists for audits of internal control systems; guidelines/templates/checklists for financial control systems.

“Preparedness risk” refers to effects on the company related to the preparation for and reduction of effects resulting from disasters. Tools one can use to minimize preparedness risk include, without limitation: guidelines/templates/checklists for establishing an emergency preparedness program; guidelines/templates/checklists for an emergency plan; guidelines/templates/checklists for a hazard vulnerability assessment.

“Startup company risk” refers to business risks that are faced, to a large extent, by startup companies. Nonlimiting examples of such risk, include the following: investor operational/reputational strength, for instance as related to the amount of investment funds managed and the return on investment; founder operational/reputational strength, for instance as related to the amount of previous investment funds secured and market cap of previous ventures.

When releasing a new product, an insurance company must develop a code set or base. This process involves associating a code with each type of claim event. “Claim event” refers to an event that would trigger an insurance claim under the new product, typically an insurance policy. Claim events are related to identified risks, e.g., business risks.

Using traditional methods, insurance company employees view the various risks associated with an insurance policy, develop codes associated with them typically using codes from other products as templates and enter the data into a database. This process is cumbersome and may take many employees (e.g., 20 or more) a significant amount of time to complete (e.g., 6 months or more).

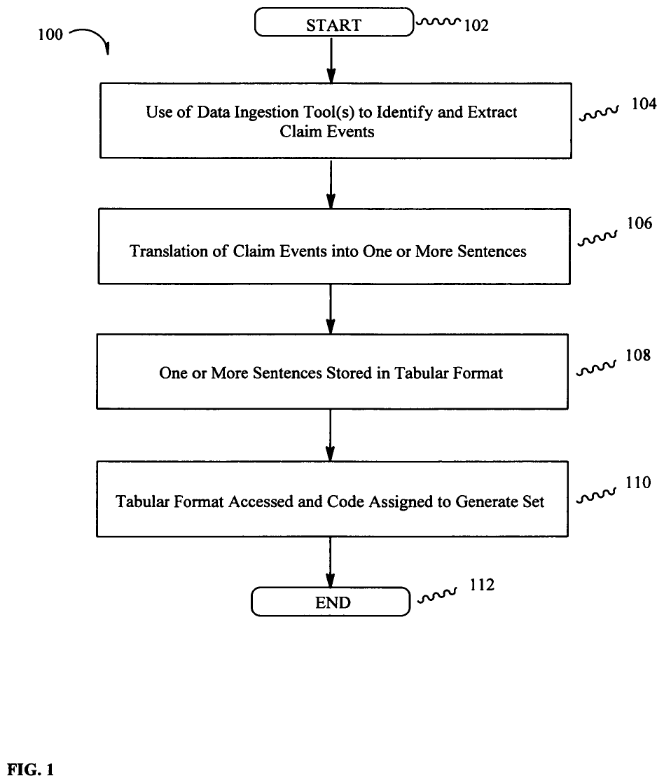

Embodiments of the present invention are described in reference to the drawings, where reference numbers are generally used to refer to elements throughout. FIG. 1 is a flow diagram illustrating an exemplary method of insurance code generation (100). At 102, the method starts. At 104, one or more data ingestion tools is used to identify and extract claim events from available databases. These are events that result in some sort of business loss (e.g., loss in financial resources, loss in valuation, etc.). At 106, each claim event is translated into one or more sentences using a natural language processing module. At 108, the one or more sentences are stored in a database in a tabular format (e.g., Excel). At 110, the tabular format from 108 is accessed and a code is assigned to each entry to generate a code set. At 112, the method ends.

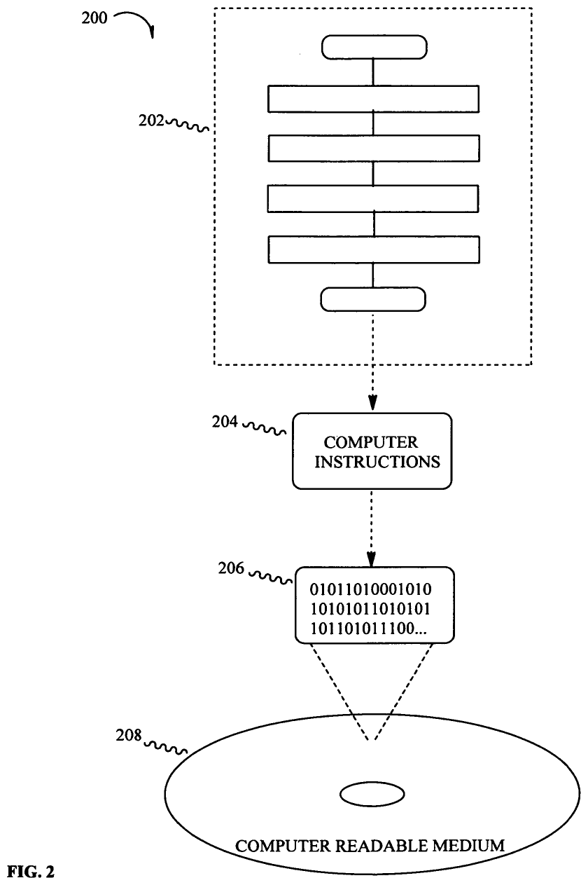

Still another embodiment involves a computer-readable medium comprising processor-executable instructions configured to implement one or more of the techniques presented herein. An example embodiment of a computer-readable medium or a computer-readable device is illustrated in FIG. 2, wherein the implementation 200 comprises a computer-readable medium 208, such as a CD-R, DVD-R, flash drive, a platter of a hard disk drive, etc., on which is encoded computer-readable data 206. This computer-readable data 206, such as binary data comprising at least one of a zero or a one, in turn comprises a set of computer instructions 204 configured to operate according to one or more of the principles set forth herein. In some embodiments, the processor-executable computer instructions 204 are configured to perform a method 202, such as at least some of the exemplary methods 100 of FIG. 1, for example. In some embodiments, the processor-executable instructions 204 are configured to implement a system. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

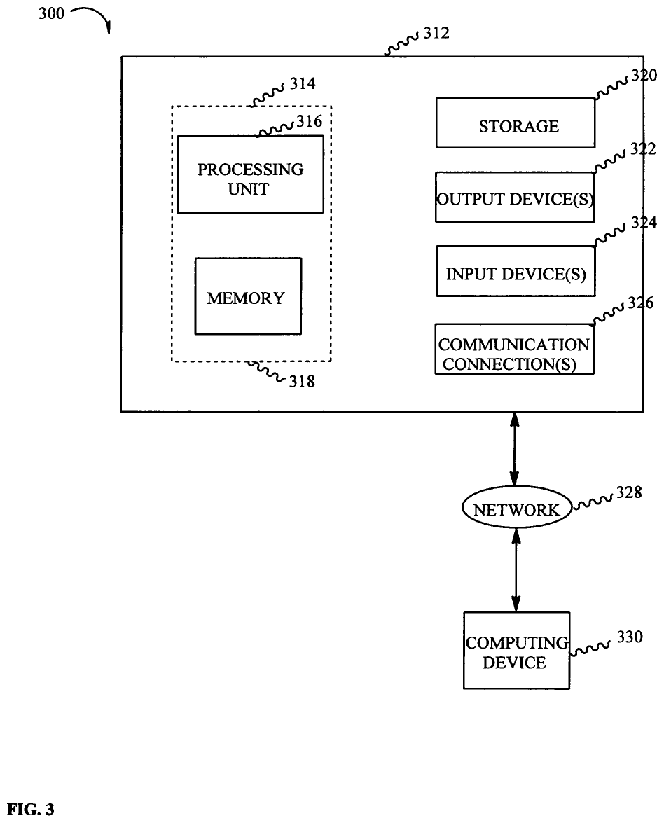

FIG. 3 illustrates an exemplary computing environment wherein one or more of the provisions set forth herein may be implemented. This figure and the following discussion provide a brief, general description of a suitable computing environment to implement embodiments of one or more of the provisions set forth herein. The operating environment of FIG. 3 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 3 illustrates an example of a system 300 comprising a computing device 312 configured to implement one or more embodiments provided herein. In one configuration, computing device 312 includes at least one processing unit 316 and memory 318. Depending on the exact configuration and type of computing device, memory 318 may be volatile (such as RAM, for example), non-volatile (such as ROM, flash memory, etc., for example) or some combination of the two. This configuration is illustrated in FIG. 3 by dashed line 314.

In other embodiments, device 312 may include additional features and/or functionality. For example, device 312 may also include additional storage (e.g., removable and/or non-removable) including, but not limited to, magnetic storage, optical storage, and the like. Such additional storage is illustrated in FIG. 3 by storage 320. In one embodiment, computer readable instructions to implement one or more embodiments provided herein may be in storage 320. Storage 320 may also store other computer readable instructions to implement an operating system, an application program, and the like. Computer readable instructions may be loaded in memory 318 for execution by processing unit 316, for example.

The term “computer readable media” as used herein includes computer storage media. Computer storage media includes volatile and nonvolatile, removable and non-removable media implemented in any method or technology for storage of information such as computer readable instructions or other data. Memory 318 and storage 320 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 312. Computer storage media does not, however, include propagated signals. Rather, computer storage media excludes propagated signals. Any such computer storage media may be part of device 312.

Device 312 may also include communication connection(s) 326 that allows device 312 to communicate with other devices. Communication connection(s) 326 may include, but is not limited to, a modem, a Network Interface Card (NIC), an integrated network interface, a radio frequency transmitter/receiver, an infrared port, a USB connection, or other interfaces for connecting computing device 312 to other computing devices. Communication connection(s) 326 may include a wired connection or a wireless connection. Communication connection(s) 326 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 312 may include input device(s) 324 such as keyboard, mouse, pen, voice input device, touch input device, infrared cameras, video input devices, and/or any other input device. Output device(s) 322 such as one or more displays, speakers, printers, and/or any other output device may also be included in device 312. Input device(s) 324 and output device(s) 322 may be connected to device 312 via a wired connection, wireless connection, or any combination thereof. In one embodiment, an input device or an output device from another computing device may be used as input device(s) 324 or output device(s) 322 for computing device 312.

Components of computing device 312 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 312 may be interconnected by a network. For example, memory 318 may be comprised of multiple physical memory units located in different physical locations interconnected by a network.

Those skilled in the art will realize that storage devices utilized to store computer readable instructions may be distributed across a network. For example, a computing device 330 accessible via a network 328 may store computer readable instructions to implement one or more embodiments provided herein. Computing device 312 may access computing device 330 and download a part or all of the computer readable instructions for execution. Alternatively, computing device 312 may download pieces of the computer readable instructions, as needed, or some instructions may be executed at computing device 312 and some at computing device 330.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

1. A method of developing an insurance code set, wherein the method comprises the steps of:
using one or more data ingestion tools to identify and extract claim events from available databases;
translating each claim event into one or more sentences using a natural language processing model;
storing the one or more sentences in a database in a tabular format;
accessing the tabular format and assigning a code to each entry,
thereby developing an insurance code set.

2. A computer system for developing an insurance code set, comprising: one or more processor; and one or more storage devices having stored thereon computer-executable instructions, which are executable by the one or more processors to cause the computer system to: use one or more data ingestion tools to identify and extract claim events from available databases; translate each claim event into one or more sentences using a natural language processing model; store the one or more sentences in a database in a tabular format; access the tabular format and assigning a code to each entry, thereby developing an insurance code set.

3. One or more hardware storage devices having stored thereon computer-executable instructions, which are executable by one or more processors of a computing system to cause the computer system to: use one or more data ingestion tools to identify and extract claim events from available databases; translate each claim event into one or more sentences using a natural language processing model; store the one or more sentences in a database in a tabular format; access the tabular format and assigning a code to each entry, thereby developing an insurance code set.
